(19) United States
(12) Patent Application Publication
(10) Pub. No.: US 2005/0277436 A1
(43) Pub. Date: Dec. 15, 2005

(54) Method of enabling a dual band handset having both PHS and GSM arrangements to be ready to receive a call in standby

(75) Inventors: Cheng-Shing Lai, Taipei Hsien (TW); Zheng-Rong Zou, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/859,224

(22) Filed: Jun. 3, 2004

(51) Int. Cl. H04M 1/00

(52) U.S. Cl. 455/552.1; 455/575.7

(57) ABSTRACT

The present invention discloses a method of enabling a dual band handset having both a low power system (e.g., PHS) and a high power system (e.g., GSM) arrangements to be ready to receive a call in standby through utilizing a dual band/dual mode antenna in cooperation with a dual band duplexer, wherein the dual band antenna has different resonant lengths in different operating frequencies. The higher of frequency the shorter of the resonant length of an antenna vibrator, the lower of frequency the longer of the resonant length of the antenna vibrator, the vibrator associated with high frequency is used when the operating frequency is low, and the increased vibrator is cut when the operating frequency is high so as to use the short vibrator only, thereby enabling the antenna to operate at either operating frequency.

### FIELD OF THE INVENTION

The present invention relates to dual band handsets and more particularly to a method of enabling a dual band handset having both PHS (Personal Handyphone System) and GSM (Global System for Mobile) arrangements to be ready to receive a call in an area covered by PHS or GSM in standby.

### BACKGROUND OF THE INVENTION

Cellular phones are widely used throughout the world due to technological advancements. Further, almost every person has a cellular phone in some countries. It is understood that our life has entered into a communication booming age. The availability of cellular phones also causes communication industry to make progress significantly in recent years. For example, there were about 1,000 cellular phone users in early 1990s. There were more than 0.35 billion cellular phone users in the world ten years later from that time. There were 0.5 billion cellular phone users in the world at the end of 2003 according to statistics of ITU (International Telecommunication Union). This is about half the users (e.g., about 0.95 billion users) of conventional fixed wire telephones. It is estimated that the number of cellular phone users can pass that of conventional fixed wire telephones after 2005. Thus, cellular phone will be the dominant communication tool in the near future. As known that, cell-based mobile communication has significantly changed the telephone technology. Accordingly, point to point call no longer exists. To the contrary, it has evolved into person to person communication. Moreover, cellular phone has advantages of being lightweight, portable, reasonable fee, roaming, without being restricted by geography, and useable in any time any place. As an end, cellular phones have become the indispensable tool for communication.

Cellular phone has evolved from a communication tool for conveying voice to one for sending information. For the type of data being sent, data is sent in an analog form in the 1st generation cellular phone. The content of data is voice. Further, both encryption and penetration are poor. As to 2nd generation cellular phone, data is sent in a digital form. Voice is digitally encoded as a packet prior to transmission. As a result, encryption is greatly enhanced. The needs for Internet access and wireless online are increased gradually due to the coming of network age. A cellular phone is designed as means for integration, control, and communication among various products in the concept of information, domestic appliances, and AI (artificial intelligence) products. As such, data transmission rate of cellular phone is required to increase significantly. But only voice transmission and processing were considered in the stipulation of the 2nd generation cellular phone. Data transmission rate of digitized voice is not high. In fact, a data transmission rate of 9.6 Kbps is sufficient for the 2nd generation cellular phone. However, such is not sufficient when data containing pictures, files, etc. are processed by the 2nd generation cellular phone. For the 2.5th generation and 3rd generation cellular phones, they are developed for processing large amount of data in the network age. Data transmission rate of the 2.5th generation cellular phone is 115 Kbps. Such significant increase of data transmission rate can satisfy the needs of still pictures transmission. Further, wireless online is finally achieved by the 2.5th generation communication specifications. For the 3rd generation cellular phone, data transmission rate is increased up to 2.4 Mbps according to its specifications. As such, dynamic pictures can be transmitted by a cellular phone. It is envisaged that a cellular phone user can even watch TV, movies, and conduct a one-on-one video conference when 3G age comes. Also, our life will be more convenient, information retrieval will be made more in time, and communication, information, and network integration will be enhanced when 3G age comes.

A cellular phone comprises software and hardware which in turn comprises a base frequency module, an intermediate frequency module, an RF (radio frequency) module, and other components. RF module comprises a PA (power amplifier), a transceiver, and a synthesizer. The intermediate frequency module comprises an AD (analog to digital) converter and a DA (digital to analog) converter. The base frequency module comprises a DSP (digital signal processor), a MCU (microcontroller unit), and a memory storage device. Other components comprise a housing, a LCD (liquid crystal display), a PCB (printed circuit board), an antenna, a keypad, a speaker, a microphone, a SIM (Subscriber Identity Module), and cells.

After the wide promotion of PHS cellular phone (i.e., PHS handset), many GSM cellular phone users want to use the PHS feature to make or receive a call in an area covered by PHS because communication fee of PHS is much cheaper than that of GSM (i.e., for saving money). As such, GSM/PHS dual band handsets are developed. For carrying out a dual band handset, following technology has to be achieved. In brief, the dual band handset having both PHS and GSM arrangements is ready to receive a call in standby irrespective as to whether the dual band handset user is in an area covered by PHS or GSM. A call can be received whenever communication is established by either PHS or GSM. A call made through PHS has a higher priority since PHS has a lower fee. Also, a dual band handset user can switch to GSM prior to making a call. Further, the dual band handset user can select to use PHS or GSM as long as it is ready.

For such feature, both PHS and GSM are designed to send or receive signals in a TDMA (time division multiple access) mode. Currently, two antennas of different operating frequencies are employed in a band ranged from 1900 MHz to 1920 MHz of PHS and in another band ranged from 890 MHz to 960 MHz of GSM respectively. Further, signal is transmitted or received in respective systems for supporting both PHS and GSM in standby and preventing interference from occurring. In such configuration, two antennas are required to mount on the dual band handset. This can increase the cost due to the mounting of another antenna. Hence, a need for improvement exists.

### SUMMARY OF THE INVENTION

A primary object of the present invention is to provide a method of enabling a dual band handset having both a low power system (e.g., PHS) arrangement and a high power system (e.g., GSM) arrangement to be ready to receive a call in standby. By utilizing the present invention, the above drawbacks of the prior art dual band handset can be overcome.

One object of the present invention is to provide a dual band/dual mode antenna in cooperation with a dual band duplexer such that it is possible of enabling a GSM/PHS dual band handset to be ready to receive a call in standby.

The above and other objects, features and advantages of the present invention will become apparent from the following detailed description taken with the accompanying drawings.

### BRIEF DESCRIPTION OF THE DRAWINGS

FIG. 1 schematically depicts the invention; and

FIG. 2 is a circuit diagram of the invention.

### DETAILED DESCRIPTION OF THE PREFERRED EMBODIMENTS

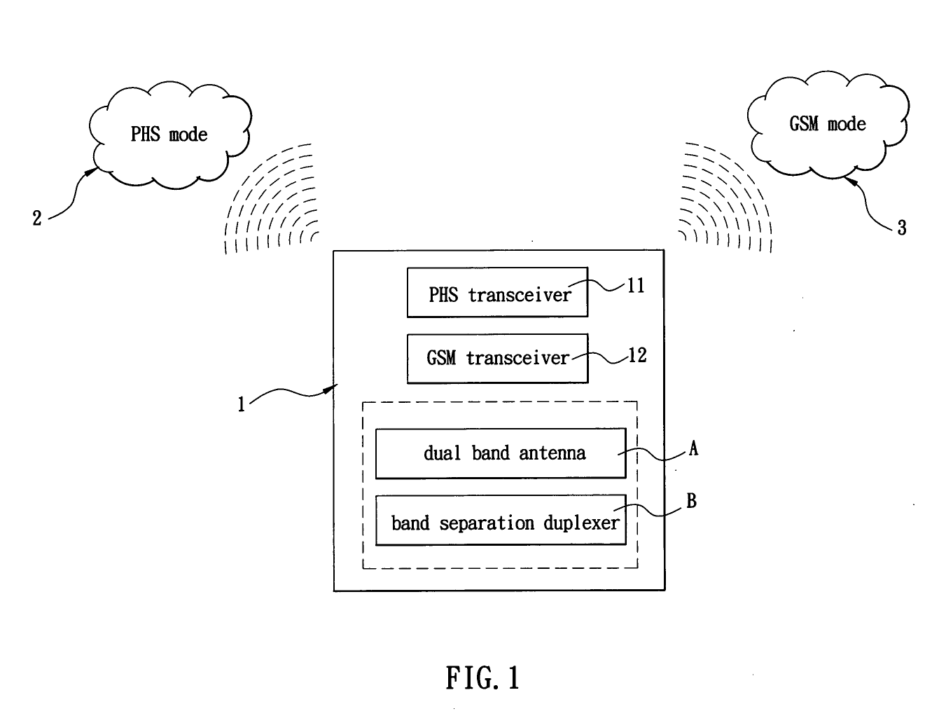

Referring to FIG. 1, there is shown a schematic system diagram of GSM900/PHS1900 dual band handset 1 in accordance with the invention. The dual band handset 1 comprises two independent PHS transceiver 11 and GSM transceiver 12. A dual band antenna A for supporting both GSM900 and PHS1900 operating frequencies at the same time and an associated band separation duplexer B are provided for being ready to receive a call in standby in two different system modes (e.g., PHS mode 2 and GSM mode 3). As a result, the dual band handset having both GSM900 and PHS1900 arrangements is ready to receive signals irrespective as to whether the dual band handset user is in an area covered by either PHS or GSM. Further, a call can be made whenever a communication is established by either PHS or GSM.

For achieving the above goal, it is important to design a dual band antenna and a band separation duplexer. The dual band antenna (i.e., at 900 MHz/1900 MHz) is designed based on the following operating frequency principles. An antenna has different resonant lengths in different operating frequencies. The higher of frequency (e.g., 1.9 GHz) the shorter of the resonant length of the antenna vibrator. Also, the lower of frequency (e.g., 900 MHz) the longer of the resonant length of the antenna vibrator. Vibrator associated with high frequency is used when operating frequency is low. Also, increased vibrator is cut when operating frequency is high (i.e., only short vibrator is used). In such a manner, an antenna is able to operate at either operating frequency. Couple vibrators, having different lengths corresponding to different operating frequencies, together such that a vibrator corresponding to a different length can operate in different operating frequencies. As an end, an antenna is able to operate in two different bands.

In the invention a band trapper is used in place of a switch so as to automatically adjust vibrator length based on different operating frequencies. A trapper is in fact a parallel resonance circuit having a resonance at the operating frequency. The parallel resonance circuit has a high impedance (i.e., open circuit) when the antenna operates in an operating frequency. That is, the vibrator is disconnected. The trapper serves as an induction coil of two series vibrators when the antenna has an input frequency lower than a resonant frequency of the trapper. To the contrary, it is equivalent to a series capacitor. Practical antenna vibrator length is shortened in either state.

It is possible of sending or receiving signals in either band by means of the dual band handset. But GSM and PHS have respective independent transceiving systems (i.e., transceivers). As such, a signal incompatible effect can be generated in sending or receiving signal when signal is sent or received by the antenna at the same time. Also, a strong signal (i.e., GSM signal) can stop a weak signal (i.e., PHS signal) from being sent or received. As an end, the purpose of enabling the dual band handset having both PHS and GSM arrangements to be ready to receive a call in standby is made impossible. Hence, it is necessary to provide a band separation duplexer between the dual band antenna and a GSM/PHS transceiver switch for satisfying the needs of transceiving GSM/PHS at the same time. A GSM signal received by the antenna is sent to the GSM transceiver for receiving via the band separation duplexer without fading. As to GSM signal bypassed to PHS transceiver, it is faded by GSM band trapper. As an end, the PHS transceiver is not adversely affected. Similarly, a PHS band trapper for fading PHS signal is provided between the antenna and the GSM transceiver so that the antenna is able to receive a PHS signal. In such a manner, it enables the dual band handset to be ready to receive PHS and GSM signals in standby at the same time. Also, there is no interference between these two modes in sending or receiving signals.

Moreover, for overcoming drawbacks (e.g., low transmission power, high frequency, short wavelength, poor building penetration capability, and no communication possible in a moving vehicle) of PHS1900Mz transceiver, a CP (circular polarization) is introduced in designing the dual band antenna. Such can decrease multi-path phase difference fading and electric field polarization conversion due to geography and/or buildings. As an end, blind areas can be reduced. This is beneficial to sending or receiving signal at PHS1900 Hz.

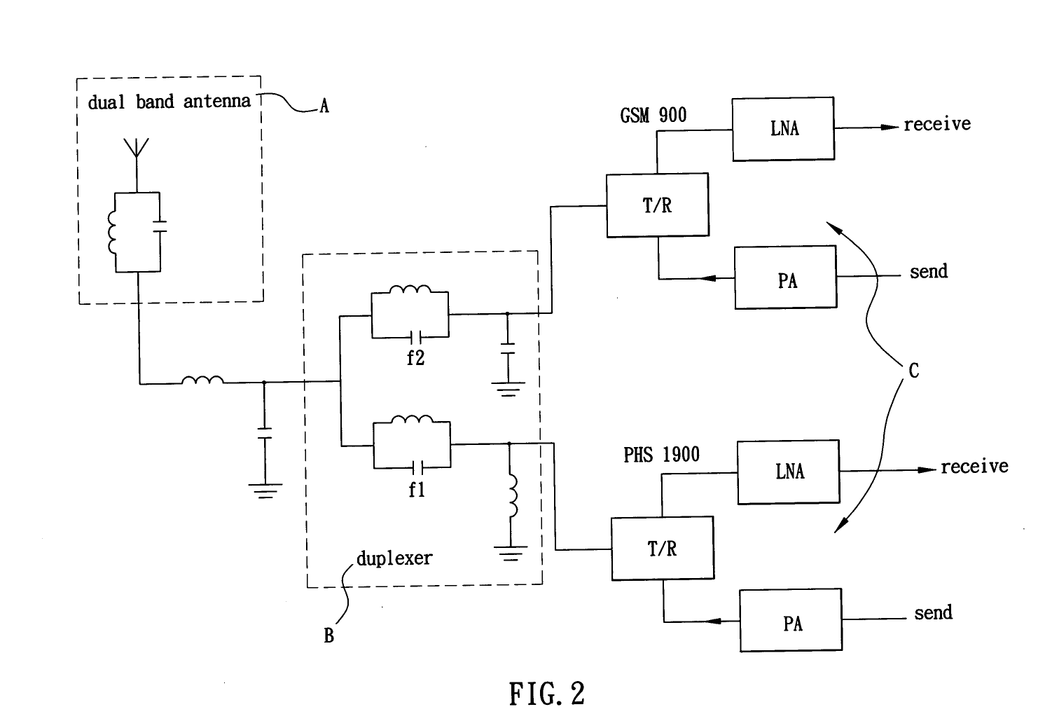

In the following embodiment, the current GSM900 MHz handset transceiving scheme and PHS1900 MHz handset transceiving scheme are utilized. Two transceivers are combined together by means of port to port communication or any other communication scheme under the control of a main CPU (central processing unit). Also, the scheme of the invention is incorporated in the front section of transceiver of the dual band-handset. Referring to FIG. 2, A, B, and C portions are provided in the front section of transceiver of the dual band handset in which A is a dual band antenna, B is a band separation duplexer, and C is implemented as a front section of PHS1900 transceiver and a front section of GSM900 transceiver. A series inductor and a parallel capacitor are provided between the A circuit and the B circuit so as to achieve 50 Ohm transmission line matching.

A band trapper of the dual band antenna A operated in one frequency is in series between two antenna vibrators having two different operating frequencies. The band trapper consists of an inductor and a parallel capacitor. At an upper end of the antenna, the trapper has a resonance at a frequency f2 ranged from 1850 MHz to 1990 MHz and a lower thereof is at one-fourth wavelength of PHS operating frequency. The GSM operating frequency of the antenna is at one-fourth wavelength of GSM operating frequency above the trapper. Thus, the antenna vibrator length is required to be longer than PHS antenna vibrator length when the antenna operates at GSM operating frequency.

The band separation duplexer B consists of two band trappers (f1 and f2) as shown in FIG. 2. The resonant frequency is f2 (i.e., 1850 MHz to 1990 MHz of the trapper) so as to fade PHS1900 MHz band signal. For GSM90 MHz band signal, it is sent to an inductor parallel to a capacitor prior to sending to GSM transceiver. The lower end has an operating frequency of f1 (i.e., 880 MHz to 960 MHz of the trapper) so as to fade GSM900 MHz band signal. For PHS1900 MHz band signal, it is sent to a capacitor in series with an inductor prior to sending to PHS transceiver. As an end, there is no interference for signal transmission between PHS and GSM. The band separation duplexer B comprises three ports in which one of them is coupled to the antenna and the remaining two are coupled to PHS and GSM transceivers respectively.

Transmission line matching schemes of A, B, and C portions are required to finish after finishing the design of dual band antenna and band separation duplexer. It is possible of adjusting gains of the original PHS and GSM transceivers for compensation if there is fading in the normal path in sending or receiving signals. In such a manner, it enables the dual band handset to be ready to receive PHS and GSM signals in standby at the same time. Also, there is no interference therebetween in making a call by choosing either one.

The dual band antenna first senses a GSM900 band signal when the dual band handset operates in a dual band mode. The signal bypasses the band trapper of the antenna prior to coupling to the duplexer. And in turn it is sent to the GSM transceiver for automatically receiving GSM call. But signal sent to PHS is disconnected. The antenna will change the antenna vibrator by itself if the antenna receives PHS band signal. In response, vibrator length is shortened and CP is enhanced. The signal is sent to the PHS transceiver for receiving via the duplexer. But signal sent to GSM is disconnected. The above principles also apply to signal sending of the dual band handset. Thus, there is no interference between PHS and GSM.

While the invention has been described by means of specific embodiments, numerous modifications and variations could be made thereto by those skilled in the art without departing from the scope and spirit of the invention set forth in the claims.

1. A method of enabling a dual band handset having both PHS and GSM arrangements to be ready to receive a call in standby, the dual band handset including two independent PHS and GSM transceivers, a dual band antenna, and a band separation duplexer associated with the dual band antenna, the method comprising the steps of:
commanding both the PHS and GSM transceivers to be ready to receive a signal in standby; and
supporting a PHS mode and a GSM mode in making a call whenever a communication is established by either one,
wherein the dual band antenna is designed based on that an antenna has different resonant lengths in different operating frequencies, the higher of frequency the shorter of the resonant length of an antenna vibrator, the lower of frequency the longer of the resonant length of the antenna vibrator, the vibrator associated with high frequency is used when the operating frequency is low, and the increased vibrator is cut when the operating frequency is high so as to use the short vibrator only, thereby enabling the antenna to operate at either operating frequency.

2. The method of claim 1, further comprising a band trapper for replacing a switch so as to automatically adjust the vibrator length based on different operating frequencies wherein the trapper is implemented as a parallel resonance circuit having a resonance at the operating frequency, the parallel resonance circuit has a high impedance as an open circuit for disconnecting the vibrator when the antenna operates in the operating frequency, the trapper serves as an induction coil of two series vibrators when the antenna has an input frequency lower than a resonant frequency of the trapper, to the contrary, the trapper serves as a series capacitor, and the practical antenna vibrator length is shortened in either state.

3. The method of claim 2, wherein the PHS and the GSM transceiver are combined together by means of port to port communication or any other communication scheme under the control of a CPU prior to incorporating in a front section of the transceiver of the dual band handset.

4. The method of claim 3, wherein the front section of transceiver of the dual band handset comprises the dual band antenna, the band separation duplexer, a front section of the PHS transceiver, and a front section of the GSM transceiver.

5. The method of claim 4, wherein the band trapper of the dual band antenna operated in one frequency is in series between two antenna vibrators having two different operating frequencies, and the band trapper comprises an inductor and a parallel capacitor.

6. The method of claim 5, wherein a CP is introduced in designing the dual band antenna so as to decrease multi-path phase difference fading and electric field polarization conversion caused by geography and/or buildings, increase penetration, and reduce blind areas.
